(19) United States
(12) Patent Application Publication
(10) Pub. No.: US 2002/0099770 A1
(43) Pub. Date: Jul. 25, 2002

(54) Hybrid communications and interest management system and method

(75) Inventors: Jonathan Lindo, Daly City, CA (US); Howard Abrams, San Mateo, CA (US)

Correspondence Address: Andrew V. Smith, Sierra Patent Group, P.O. Box 6149, Stateline, NV, 89449, US

(73) Assignee: Muse Corporation

(21) Appl. No.: 09/923,769

(22) Filed: Aug. 6, 2001

Related U.S. Application Data
(60) Provisional application No. 60/231,390, filed on Sep. 8, 2000.

(51) Int. Cl. G06F 15/16; G09G 5/00

(52) U.S. Cl. 709/203; 709/218; 345/757; 709/205

(57) ABSTRACT

A method, software program and computer network allow multiple users to communicate in a shared virtual environment while efficiently using available data transmission capabilities for providing to each user efficient communications access to interesting entities such as other users and generalized information. The network preferably includes a host interactivity server and multiple client computers. The method includes establishing a connection and a context between the server and each client computer and negotiating an interest expression of a client based on information relating to a subject user, and based on available bandwidth and network traffic. Transmission is, based the interest expression, then permitted to the client of interesting entities, while uninteresting entities are filtered. Transmission is then also permitted to other users having an interest in the subject user information relating to the subject user, while the information relating to the subject user is filtered from being transmitted to other users not having an interest in the subject user. Dynamic interest update information of the subject user is used to negotiate an updated interest expression. Previously interesting entities may then become uninteresting, and previously uninteresting other entities may become interesting, and likewise the client to other users, depending on the updated interest expression. Updated information relating to other entities can have a similar effect with respect to those other entities.

### PRIORITY

The present application claims the benefit of priority to U.S. provisional patent application No. 60/231,390, filed Sep. 8, 2000.

### BACKGROUND OF THE INVENTION

1. Field of the Invention

The invention relates to communications among multiple users in a shared network environment, and particularly to interest management among users for efficient use of users' online time and bandwidth, and on system and client computer data transmission hardware and software capabilities.

2. Discussion of the Related Art

The internet has provided a mechanism by which persons logged on through an ISP from a terminal device such as a personal computer, a set top box, a television set configured for browsing the internet such as using WebTV™, a cellular phone, a pager, a PDA such as a palm™ or similar device, or any other internet, web or network capable device, may can communicate with other such persons, and browse for content. More and more persons go online everyday with varied interests. The number of web sites and amount of available content is growing even faster. It is desired to be able to focus online users to facilitate their involvement in the exchange of information, and interactions with other users, each of which that they find interesting, and correspondingly to filter uninteresting generalized information and exchange between users uninterested in each other. In this way, users' may browse content and communicate with other users in a more efficient manner.

Another consideration in managing communications over the internet, or other user-centered electronic network, relates to limitations on the bandwidth or amount of information flow that the network and/or users' terminal devices can handle. That is, it is typically desired to transmit far more information than may be transmitted with available bandwidth. Compression/decompression software can reduce the amount of information that is flowed per amount of content actually sent and received, but resolution losses limit how much any particular content item may be compressed before falling below a prescribed or desired resolution tolerance. Faster modems, DSL, T-lines, and other hardware improvements will continue to improve users' ability to quickly exchange larger amounts of information. It is desired to improve the rate of flow of interesting information to, from or between users for a given compression ratio of the data and modem speed.

The ability of the network itself to handle traffic or information flowing between a large number of users is another concern depending on such factors as router and server capabilities. It is desired to have a communications platform that efficiently and automatically focuses users to have access to generalized information and other users that are interesting to them, while filtering uninteresting other users and information, particularly for communications and data exchange involving rich media content. In this way, traffic may be controlled by improving the quality or significance, on average, of the information that is exchanged by each user. This may be of particular advantage for communications that use a large amount of bandwidth, such as may include rich media and/or three-dimensional content.

### SUMMARY OF THE INVENTION

In accordance with these objects, methods, server and client software programs and a computer network are each provided which allow multiple users to communicate in a shared virtual environment while efficiently using available data transmission capabilities for providing to each user efficient communications access to interesting other users and information. The network includes an interactivity server and multiple client computers. A method, which may be performed by one or more processors based on instructions encoded within the software programs, includes establishing a connection and a context between the server and a client computer and negotiating an interest expression of a client based on information input by and/or relating to a subject user, and based on available bandwidth and network traffic. Transmission is also permitted to the client of interesting generalized information and information relating to interesting other users, while uninteresting generalized information and information relating to uninteresting other users is filtered.

Preferably, transmission is then also permitted to other users having an interest in the subject user information relating to the subject user, while the information relating to the subject user is filtered from being transmitted to other users not having an interest in the subject user. Dynamic interest update information of the subject user may be used to renegotiate the interest expression. After the updated interest expression is generated, previously interesting other users or generalized information may then become uninteresting, and previously uninteresting other users and generalized information may become interesting, and likewise the client to other users. Updated information relating to other users has a similar effect with respect to those other users.

### BRIEF DESCRIPTION OF THE DRAWINGS

FIG. 1 illustrates in block form a method relating to a client software program according to a preferred embodiment.

FIG. 2 illustrates in block form a further method relating a client software program according to a preferred embodiment.

FIG. 3 illustrates in block form a method relating to a server, peer-to-peer, nodal or hybrid network software program according to a preferred embodiment.

FIG. 4 illustrates in block form a further method relating to a server, peer-to-peer, nodal client or hybrid network software program according to a preferred embodiment.

FIG. 5a illustrates in block form a first method for dynamically updating information of a subject client utilizing a server according to a preferred embodiment.

FIG. 5b illustrates in block form a second method for dynamically updating information of a subject client relating to a peer-to-peer, nodal or hybrid network software program according to a preferred embodiment.

FIG. 6a illustrates in block form a first method for dynamically updating information of clients other than a subject client utilizing a server according to a preferred embodiment.

FIG. 6b illustrates in block form a second method for dynamically updating information of clients other than a subject client relating to a peer-to-peer, nodal or hybrid network software program according to a preferred embodiment.

FIG. 7 illustrates in block form a method relating to a hybrid network software program according to a preferred embodiment.

FIG. 8a illustrates a server centered network architecture according to a preferred embodiment.

FIG. 8b illustrates a peer-to-peer network architecture according to a preferred embodiment.

FIG. 8c illustrates a hybrid network architecture according to a preferred embodiment.

FIG. 8d illustrates a nodal architecture according to a preferred embodiment.

FIG. 8e illustrates a multicast architecture according to a preferred embodiment.

FIG. 9 is a first illustration of a shared 3D virtual environment including representative user objects according to a preferred embodiment.

FIG. 10 is a second illustration of a shared 3D virtual environment including representative user objects according to a preferred embodiment.

### DETAILED DESCRIPTION OF THE PREFERRED EMBODIMENTS

The preferred embodiment is drawn to communications between users and information extraction from a network. Particular advantage is recognized when the content and communications being transmitted use a large amount of bandwidth. Examples include transmission of rich media and/or three-dimensional content. Some examples are described in U.S. patent application Ser. Nos. 09/375,476 and 09/498,632, each of which is assigned to the same assignee and is hereby incorporated by reference. Particular advantage is also recognized when the system or network being used has a limited ability to handle the traffic that can arise such as when demands rises above expected demand and at peek periods when many users are connected to the network.

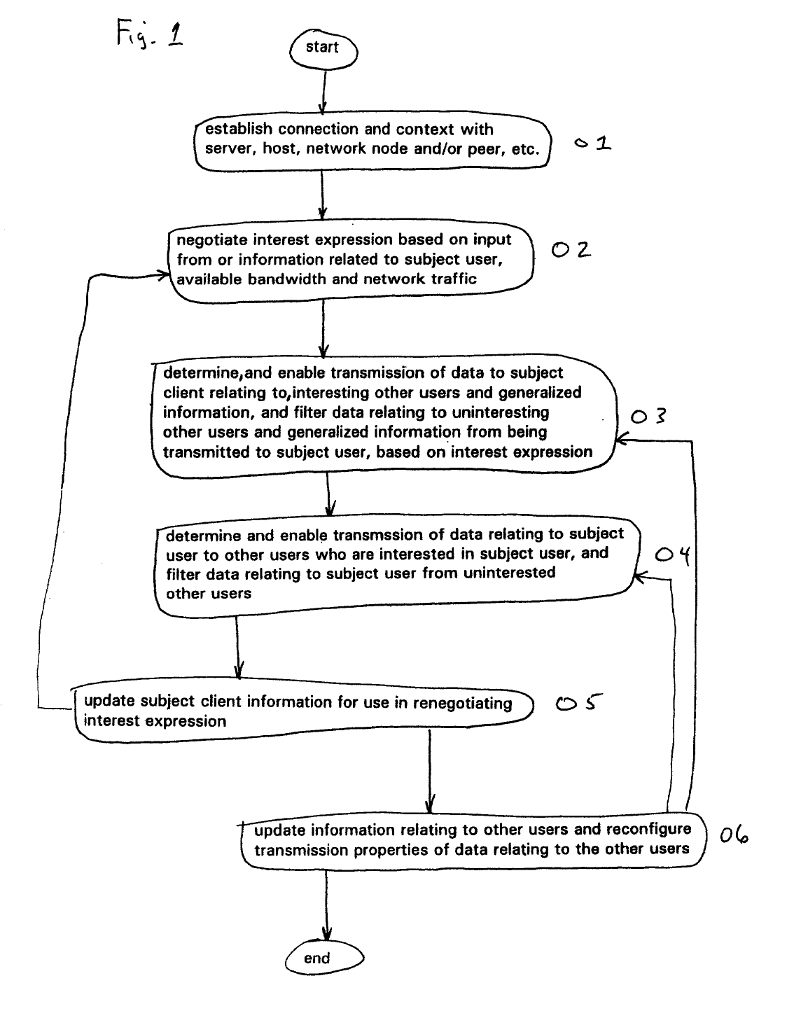

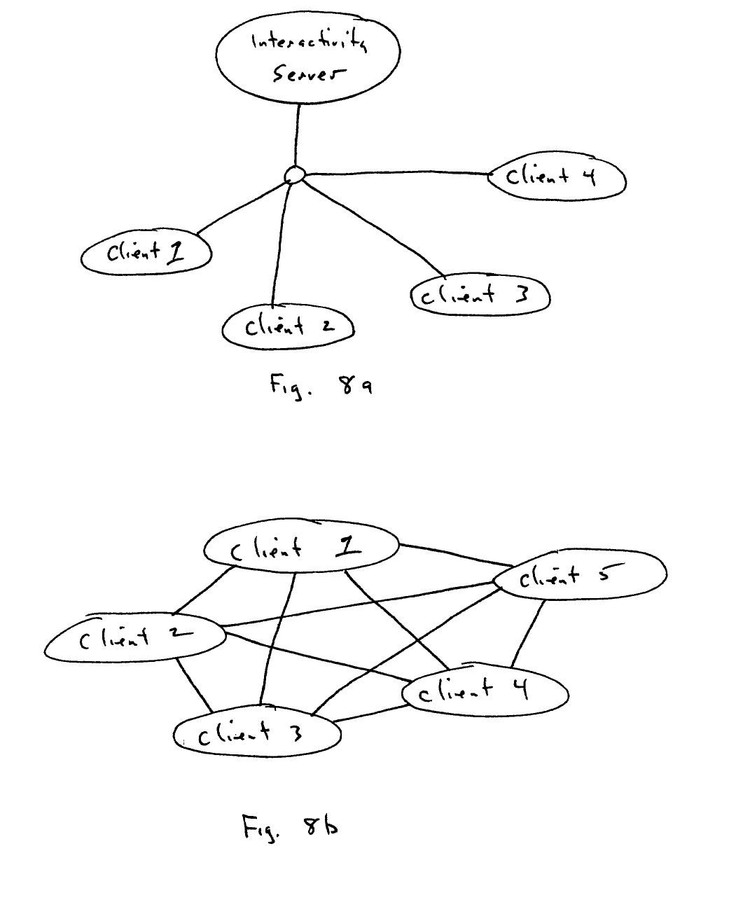

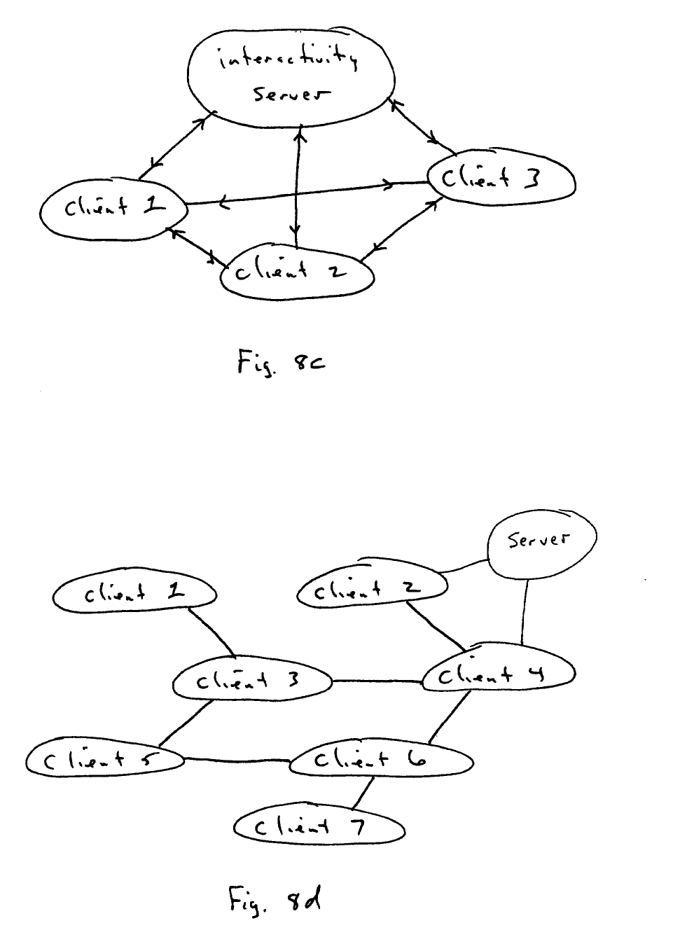

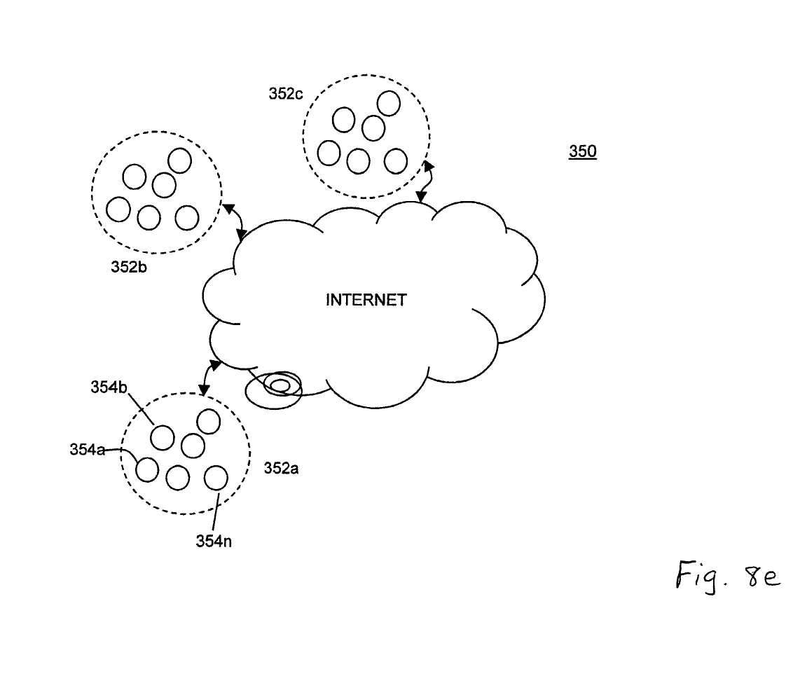

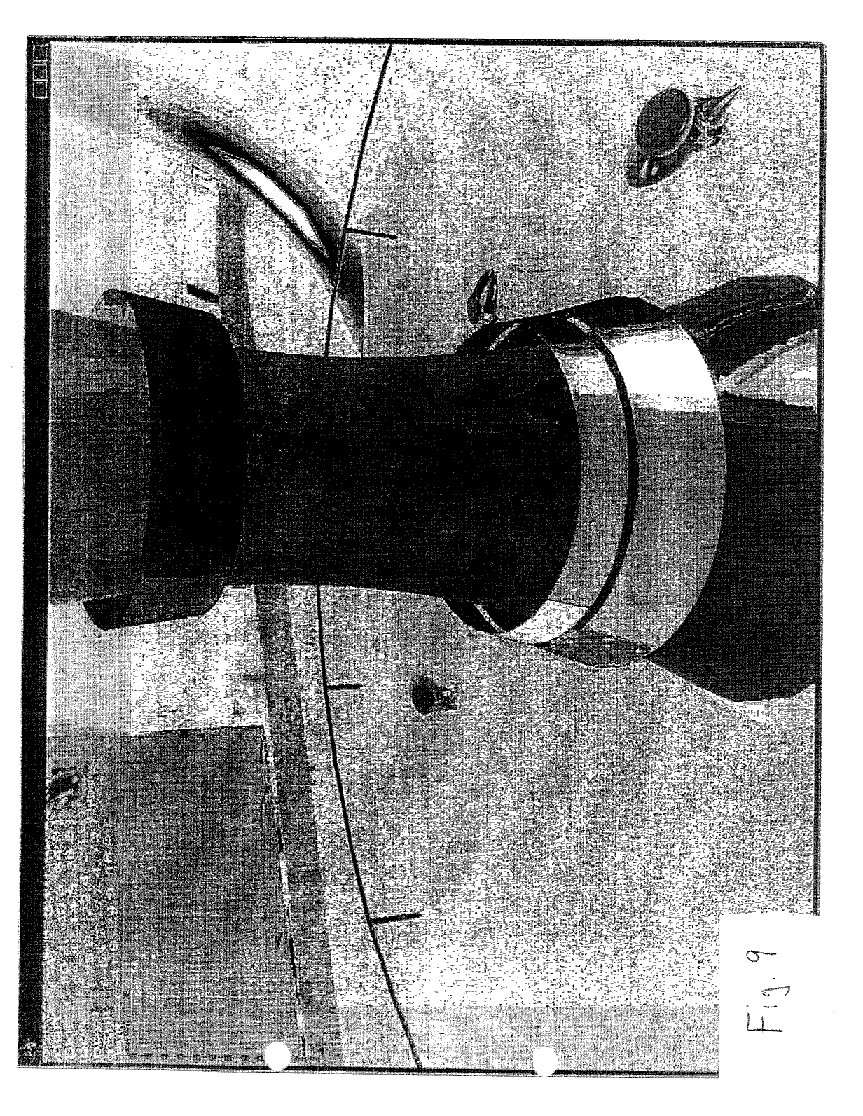

FIG. 1 illustrates in block form a method relating to a client software program according to a preferred embodiment. In a first operation O1, a client computer of a subject user establishes a connection and a context with an interactivity server, host, network node, peer, etc. The interactivity server is preferably used. However, another host computer connected to the network the user desires to be connected to may be used. The subject user may connect with a peer or another user running the same or a similar client program. The subject user may connect at a network node of a nodal network configuration of client computers, wherein each client is connected to other clients via one or more nodes. The nodes may be other clients or servers or computers running nodal network software. Some network architectures, and any combinations thereof, any of which may be used in accord with the preferred embodiment, among others known to those skilled in the art, are described and illustrated in more detail below with respect to FIGS. 8a-8e.

The context that is communicated from the client in the operation O1 of FIG. 1 includes data or information relating to the subject user. Such information may be related to the client computer that is considered to be related to the subject user in this regard. The context relayed to the server, host, node, etc. preferably includes protocol information of the client computer, e.g., such that handshaking is performed. Hardware and software information is also exchanged between the two computers and/or software instructed agents.

The information may be input by the user or may be derived from activities of the user. The information may relate to a past, present or future or desired location in a virtual world occupied by the user or user's character or virtual representation. The location of a user and a predetermined virtual area or volume surrounding this location and items therein may be determined to be more interesting than items in further displaced areas of the virtual volume. The interest expression may be generally flexible or dynamic depending on system parameters and constraints.

The context of the client or of the subject user associated with the client may also be included within the interest expression. The interest expression may include a particular geometry within the virtual world the user is roaming or sharing or browsing. The interest expression may include interests or features of the subject user such as may be derived from a profile input by the user and/or derived from activities or movements of the user. The interest expression may be a boolean expression either directly input by the subject user or derived from such input. The interest expression may be predetermined, flexible and/or dynamic depending on system parameters and constraints.

A second operation in the preferred method illustrated at FIG. 1 involves a negotiation of an interest expression for the subject user. The interest expression is formed based on interests of the subject user and on the bandwidth available to the network or to the client for transmitting all of the information that the user associated with the client desires to send, and on system hardware and software configurations and traffic. The interests of the user may be input directly by the user, e.g., in a boolean or plain language expression. The user's interests may derived from activities of the user, such as may be obtained using a cookie or web-site wrapper or query program. The user's interests may be derived from the user's profile, including any information such as age, marital status, address, income, hobbies, etc., and any other information that may be in a user's profile, as understood by those skilled in the art. The information may relate to other user's that the user has had interactions with. The information may relate to the interest expression of the user. The information may relate to a geographical or subject matter area, or another or combination of ways to group other users and/or generalized information available on the network.

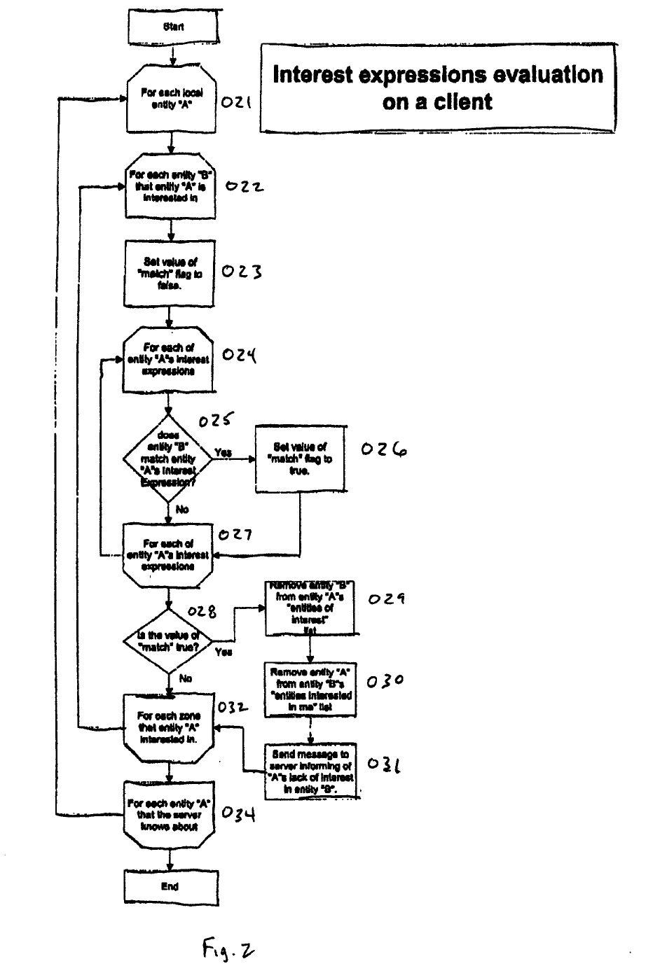

The user's interests are balanced by the network and the user's bandwidth and/or on local and system-wide traffic, and also preferably on an understanding of what a desired amount of information may be, given a user's limited ability to deal with information or other users in a limited amount of time. Thus, if the user has a smaller bandwidth to work with or limited hardware or software resources, or that is available to the user for communicating over the network, then the user's interest expression would be more limited. Likewise, if system traffic is high, then the user's interest expression may be more limited, as well. A subject user may also express a desired size of the interest expression, such as how much information or how many other users the subject user is interested in, and some weight may be accorded this input of the subject user, e.g., to reduce the size of the interest expression of the user even though the user might otherwise be allowed a larger interest expression. The subject user may indicate groups of entities that may be interest, wherein the server would check to see if those entities in fact match the interest expression of the user. These entities specifically listed are included in the information related to the subject user's interests, and may in some instances be the only such information along with bandwidth and system traffic information. An entity may be a user, an object, an item of generalized information, an advertisement, web-site or web-page, web cast, multicast email, announcement, news group, bulletin board, communication channel, video and/or audio clip or the like. This feature is described in more detail at FIG. 2.

The subject user may have more than one interest expression. Other users and/or generalized information may be interesting or uninteresting for each interest expression, as described below. Also, other users and/or generalized information may be interesting or uninteresting based on a combination of any two or all of the interest expressions of the subject user. Generalized information may include any information other than that information which is available as relating to other users. Examples of such information are information contained in content databases such as may be handled by one or more content servers, advertisements, web sites, hypertext links to other locations in the virtual environment, information available for reading by a local entity embedded within the simulation, etc. In general, such information and any other independent data source may be referred to an entity with respect to this description.

Once the interest expression is negotiated and determined, then operation O3 is performed according to the preferred method of FIG. 1. Some other users will be deemed “interesting” to the subject user, and others will be deemed “uninteresting” to the subject user. Other generalized information will likewise be considered interesting or uninteresting to the subject user based on the interest expression. Interesting other users and interesting generalized information will be made more available than other users and generalized information. Uninteresting other users and uninteresting generalized information will be made less available than other users and generalized information. The virtual world may be divided into interesting and uninteresting users and generalized information, or may also include other groups or levels other users and generalized information depending on the degree of interest the subject user is deemed to have based on the interest expression.

Using the interest expression of the subject user, and having determined the other users and generalized information that the user is interested or not interested in, transmission is enabled of data to the subject user relating to the interesting other users and/or generalized information. In addition, data related to uninteresting other users and/or generalized information is filtered from being transmitted to the client computer associated with the subject user. Thus, a particular amount of data is transmitted to the subject user, preferably none of which is uninteresting, and more preferably all of which is interesting, to the subject user.

According to the preferred embodiment set forth in block form at FIG. 1, operation O4 is next performed. In operation O4, transmission is enabled of data relating to the subject user to other users having an interest in the subject user. The data relating to the subject user is also preferably filtered from being transmitted to uninterested other users. This step may be blockable based on the wishes or input of the subject user notwithstanding the other users' interests.

The interest expression of the subject user is preferably dynamic. That is, the interest expression is preferably updated depending on activities and input of the user, or changes in the virtual environment that the user is in. At operation O5 of the preferred method of FIG. 1, updated information relating to the subject user is used to renegotiate the interest expression. Once the interest expression of the subject user is renegotiated at operation O2, then operations O3 and O4 are repeated. Some previously interesting other users and/or generalized information may then become uninteresting, and some previously uninteresting other users may then become interesting, based on the new interest expression.

In addition, information relating to other users may be updated dynamically, as well. Thus, other users may move between being interesting to uninteresting, or vice-versa, depending on how their information evolves with respect to the interest expression of the subject user. The exchange of updates may involve an interactivity server and may instead occur between clients without the use of such a server in a peer-to-peer or client-to-client manner. In addition, a one-to many exchange may also occur such as from one client to multiple other clients, such as in a multicast networking arrangement.

At operation O6, information relating to other users is updated, and transmission properties of data relating to the other users is reconfigured. In addition to the other users becoming interesting or uninteresting to the subject user, the subject user may become interesting or uninteresting to some of these other users based on the updated information. Then, operations O3 and O4 are repeated as a result of the sharing of the updates. The updating operations O5 and/or O6 may be repeated many times, accompanied by the performance of the operations O2, O3 and/or O4.

FIG. 2 illustrates in block form a further method relating a client software program according to a preferred embodiment. At operation O21, information relating to an entity “A” is read which may be related to the subject user discussed above with respect to FIG. 1. Then, at operation O22, it is determined which other entities “B” have been flagged as being potentially or actually interesting to entity A. The entities B may be other users, other objects in the virtual environment, or generalized information available on the network or in the virtual environment.

At operation O23, a match flag is set to false for each entity B that entity A may be interested in. Then, an interest expression of entity A is read at operation O24. It is determined at operation O25 whether entity B matches entity A's interest expression. If entity B is determined to match the interest expression, then at operation O26, the match flag is set to true. Then at operation 027, the next interest expression of entity A, if any, is read, which returns the method to operation O24. If entity B is determined not to match the current interest expression of entity A, then the next interest expression of entity A, if any, is read at operation O27 which returns the method to operation O24.

If entity B is determined not to match entity A's interest expression, it is next determined at operation O28 whether the current value of match is true. If the value of match is true for entity B when it has been determined that entity B does not match entity A's interest expression, then entity B is removed from entity A's “entities of interest” list at operation O29. Entity A is also removed from entity B's “entities interested in me” list at operation O30. A message is also sent to the interactivity server, host, node, peer, etc. (see above) informing of entity A's lack of interest in entity B at operation O31. An operation of reading a next zone of interest of entity A is read at operation 32, which returns the method to operation 22, for repeating the process for each of those entities B that entity A may have an interest in.

If the value of match is false for the entity B that has been determined not to match entity A's interest expression, then at operation 32, a next zone of interest of entity A is read returning the method to operation O22, for repeating the process for each of those entities B that entity A may have an interest in. At operation O34, the server, etc. (see above) next repeats the process beginning at operation O21 for a next entity A that the server knows about.

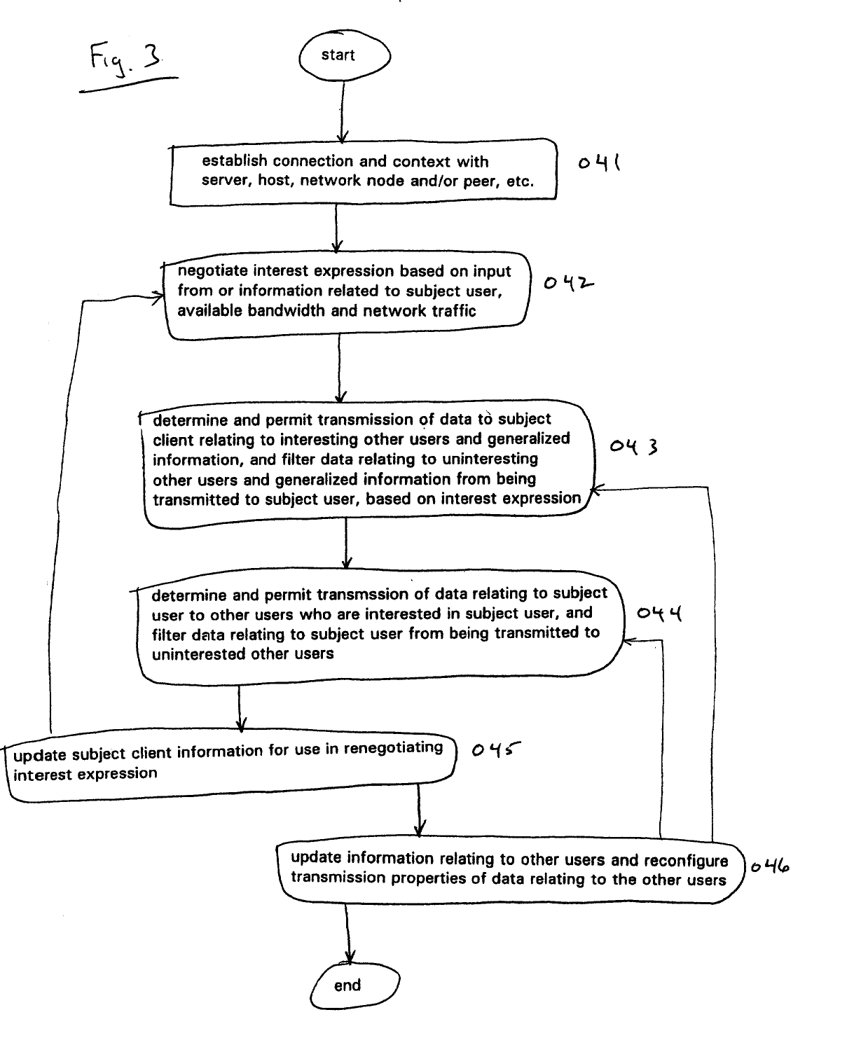

FIG. 3 illustrates in block form a method relating to a server, peer-to-peer, nodal, one-to many multicast, alternate host or hybrid network software program according to a preferred embodiment. A server may be used in any of the server, nodal or hybrid architectures, and the method of FIG. 3 will be described with respect to those architectures.

In a first operation O41, the server establishes a connection and a context with a client computer of a subject user. As discussed, another client may host the subject client in a localized web or nodal network structure. The host client may connect with the subject client in a peer relationship and/or may be running the same or a similar client program as the subject client. The subject user related to the subject client may connect at a network node of a nodal network configuration of client computers, wherein each client is connected to other clients via one or more nodes. The nodes may be other clients or servers or computers running nodal network software. Some network architectures that may be used are described with respect to FIGS. 8a-8e, below.

The context that is communicated from the client to the server in the operation O41 of FIG. 3 includes data or information relating to the subject user. Such information may be related to the client computer that is considered to be related to the subject user in this regard. The context relayed to the server preferably includes protocol information of the client computer, e.g., such that handshaking is performed. Hardware and software information is also exchanged between the two computers.

The information may be input by the user or may be derived from activities of the user. The information may relate to a past, present or future or desired location in a virtual world occupied by the user or user's character or virtual representation. This location and a predetermined virtual area or volume surrounding the location may be involved or taken into account within the interest expression, and may be predetermined, flexible or dynamic depending on system parameters and constraints.

The context of the client or of the subject user associated with the client may also be included or taken into account within the interest expression. The interest expression may involve or take into account a particular geometry within the virtual world the user is roaming or sharing or browsing. The interest expression may involve or take into account interests or features of the subject user such as may be derived from a profile input by the user and/or derived from activities of the user. The interest expression may involve a boolean expression either directly input by the subject user or derived from such input. The interest expression may be predetermined, flexible and/or dynamic depending on system parameters and contraints.

A second operation in the preferred method illustrated at FIG. 3 involves a negotiation of an interest expression with the client of the subject user. The interest expression is formed based on interests of the subject user and on the bandwidth available to the client, and on system hardware and software configurations and traffic. The server is aware of the system traffic, and made aware of the network's local and wide area bandwidth, and on the client's, bandwidth capabilities and interests, preferably at operation O41. The interests of the user may be input directly by the user, e.g., in a boolean or plain language expression. The user's interests may be derived from activities of the user, such as may be obtained using a cookie or web-site wrapper program. The user's interests may be derived from the user's profile, including any information such as age, marital status, address, income, hobbies, etc., and any other information that may be in a user's profile, as understood by those skilled in the art. The information may relate to other user's that the user has had interactions with. The information may relate to or be taken into account within the interest expression of the user. The information may relate to a geographical or subject matter area, or another or combination of ways to group other users and/or generalized information available on the network.

The server balances the user's interests in generating the interest expression with network and/or the available bandwidth to the user and/or on system traffic, and also preferably on an understanding of what a desired amount of information may be for the user, given a user's limited ability to deal with information or other users in a limited amount of time. Thus, if the user has available a smaller bandwidth, then the user's interest expression is more limited. Likewise, if system traffic is high, then the user's interest expression will be more limited, as well. A subject user may also express a desired size of the interest expression, such as how much information or how many other users the subject user is interested in, and some weight may be accorded this input of the subject user. The subject user may indicate groups of entities that may be interest, wherein the server would check to see if those entities in fact match the interest expression of the user. This is described in more detail at FIG. 4.

The subject user may have more than one interest expression. Other users and/or generalized information may be interesting or uninteresting for each interest expression, as described below. Also, other users and/or generalized information may be interesting or uninteresting based on a combination of any two or all of the interest expressions of the subject user. The generalized information may include any information other than that information which is available as relating to other users. Examples of such information are information contained in content databases such as may be handled by one or more content servers, advertisements, web sites, hypertext links to other locations in the virtual environment, information available for reading by a local entity embedded within the simulation, and/or other available entities.

Once the interest expression is negotiated and determined, then operation O43 is performed according to the preferred method of FIG. 3. Some other users will be deemed “interesting” to the subject user, and others will be deemed “uninteresting” to the subject user. Other generalized information will likewise be considered interesting or uninteresting to the subject user based on the interest expression. Interesting other users and interesting generalized information will be made more available by the server than other users and generalized information. Uninteresting other users and uninteresting generalized information will be made less available by the server than other users and generalized information. The virtual world may be divided into interesting and uninteresting users and generalized information, or may also include other groups or levels of other users and generalized information depending on the degree of interest the subject user is deemed to have, again, based on the interest expression.

Using the interest expression of the subject user, and having determined the other users and generalized information that the user is interested or not interested in, transmission is permitted by the server of data to the subject user relating to the interesting other users and/or generalized information. In addition, data related to uninteresting other users and/or generalized information is filtered by the server from being transmitted to the client computer associated with the subject user. Thus, a particular amount of data is transmitted to the subject user, preferably none of which is uninteresting, and more preferably all of which is interesting, to the subject user.

According to the preferred embodiment set forth in block form at FIG. 3, operation O44 is performed. In operation O44, transmission is permitted by the server of data relating to the subject user to other users having an interest in the subject user. The data relating to the subject user is also preferably filtered from being transmitted to uninterested other users. This step may be blockable based on the wishes or input of the subject user notwithstanding the other users' interests.

Operation O44 may be performed, in an alternative to the method set forth at FIG. 3, in a peer-to-peer or client-to-client method. In this sense, this alternative method is a “hybrid” communications method. That is, the server is initially involved in operations O41-O43, such as establishing a connection and a context with the subject client (operation O41), negotiating an interest expression with the subject client (operation O42) and permitting transmission to the subject client of data relating to interesting other users and interesting generalized information (operation O43). Then, information that the subject user receives regarding other users (see operation O46), and information that the other users receive regarding the subject user (operation O44), are exchanged without going through the server. Instead, clients receive information about other clients after the initial operations O41-O43, and exchange updated information between themselves, e.g., user routing technology that chooses a most efficient pathway from one client to the other, wherein there is no particular server that the information is always programmed to go through. Similar principles may be applied in a one-to-many multicast approach, wherein one client exchanges information with multiple other clients.

The interest expression of the subject user is preferably dynamic. That is, the interest expression is preferably updated depending on activities and input of the user, or changes in the virtual environment that the user is in. At operation O45 of the preferred method of FIG. 3, updated information relating to the subject user is used to renegotiate the interest expression. Once the interest expression of the subject user is renegotiated, then operation O43 is repeated. Some previously interesting other users and/or generalized information may then become uninteresting, and some previously uninteresting other users may then become interesting, based on the new interest expression.

In addition, information relating to other users may be updated dynamically, as well. Thus, other users may move between being interesting to uninteresting, or vice-versa, depending on how their information evolves with respect to the interest expression of the subject user. These changes of status among users may occur directly between the users based on the programming of the clients, such that the server is not used for exchanges of updates and interesting/uninteresting status updates between clients. Such a server may, however, be used.

At operation O46, this information relating to other users is updated, and transmission properties of data relating to the other users is reconfigured. In addition to the other users becoming interesting or uninteresting to the subject user, the subject user may become interesting or uninteresting to some of these other users based on the updated information. Operations O43 and/or O44 are then performed in view of the updated information. The updating operations O45 and/or O46 may be repeated many times, accompanied by the performance of the operations O42, O43 and/or O44.

FIG. 4 illustrates in block form a further method relating to a server, peer-to-peer, nodal client, one-to-many multicast or hybrid network software program according to a preferred embodiment. At operation O51, information relating to an entity “A” is read which may be related to the subject user discussed above with respect to FIG. 3. Then, at operation O52, it is determined which other zones entity A has indicated an interest in or which have been otherwise flagged as being potentially or actually interesting to entity A. Entity A may be interested in one or more zones.

The extent of each zone is determined preferably other than from the interest expression or expressions of entity A, and preferably is related to a position within the virtual environment that entity A is currently located in, the traffic within and around the zone, and on bandwidth, system traffic, etc. as described above. For example, a “popular” zone within the simulation may have many users nearby. In this case, the extent of any user's zone of interest will be smaller than when entity A's zone of interest is relatively unpopulated by other users. Those entities B that are within a zone of interest of entity A are flagged as potentially being “interesting” to entity A. In this context, a zone may be considered a grouping of entities, such as may be handled in an efficient manner on the server and/or the client.

At operation O53, information relating to one entity of one or more entities B that is indicated as being within the current zone is read. As discussed above, entity B may be another user/client, information posted or embedded within the virtual environment, an advertisement or offer, information from a local database, a local or wide area network database or a remote database, a link, a web site, content available for pulling into the client to be read by the user or pushing from another source to the user/client, a bulletin board, a live webcast or archive, etc.

At operation O54, it is determined whether entity A is the same or different than entity B, since entity A will likely be within the current zone. If entity A is in fact entity B, then at operation O65, a next entity B, if any, is selected as the current entity B and the method returns to operation O53.

If entity A is not entity B, the method goes to operation O55 from operation O54. At operation O55, it is determined whether entity B is already in entity A's “entities of interest” list. If entity B is already in entity A's entities of interest list, then the method returns to operation O65, and a next entity B, is any, is selected. If entity B is not already in entity A's entities of interest list, then a match flag is set to false at operation O56. The fact that entity B is within a zone of interest of entity A preferably does not mean that entity A is necessarily interested in entity B.

At operation O57, a process of determining whether entity B matches any interest expression of entity A is begun, which will preferably be determinative of whether entity A is, at least currently, interested in entity B. An interest expression of entity A is selected at operation O57. Then, at operation O58, it is determined whether entity B matches the current interest expression of entity A. If not, then at operation O60, a next interest expression of entity A, if any, is selected and the method returns to operation O57. If entity B does match the current interest expression of entity A, then the match flag is set to true, and the method returns to operation O60 to determine whether entity B is a match for any other interest expression of entity A. Another match might make entity B “doubly interesting” to entity A.

At operation O61, it is determined whether the value of match is true or false. If the value of match is true, then entity B is added to entity A's entities of interest list at operation O62. At operation O63, entity A is added to entity B's “entities interested in me” list. A message may be sent in some form to entity A at operation O64 informing entity a of his interest in entity B. The method then returns to operation O65, wherein a next entity B, if any, within the current zone of interest of entity A selected at operation O52, is selected, and the method is returned to operation O53.

When no further entities B are within the current zone of interest of entity A as selected at operation O52, then at operation O66, a next zone of interest of entity A, if any, is selected, and the method returns to operation O52. When all of the zones of interest of entity A have been considered and processed through the operations O52-O66, then the server moves to a next entity A, if any, that the server knows about and the method returns to operation O51.

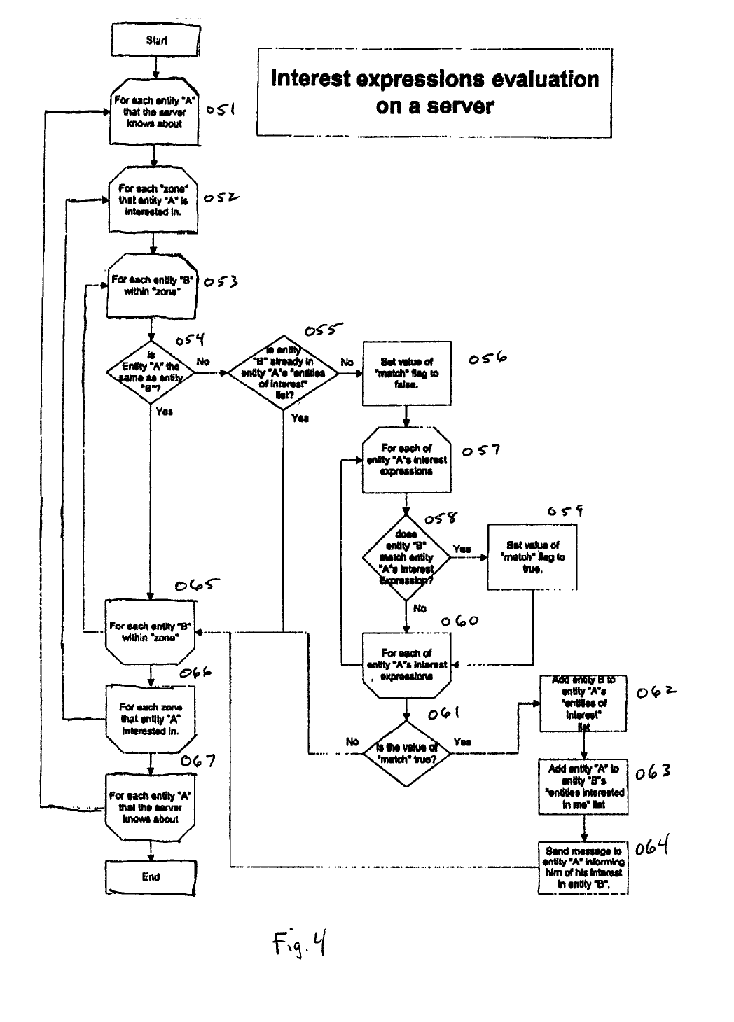

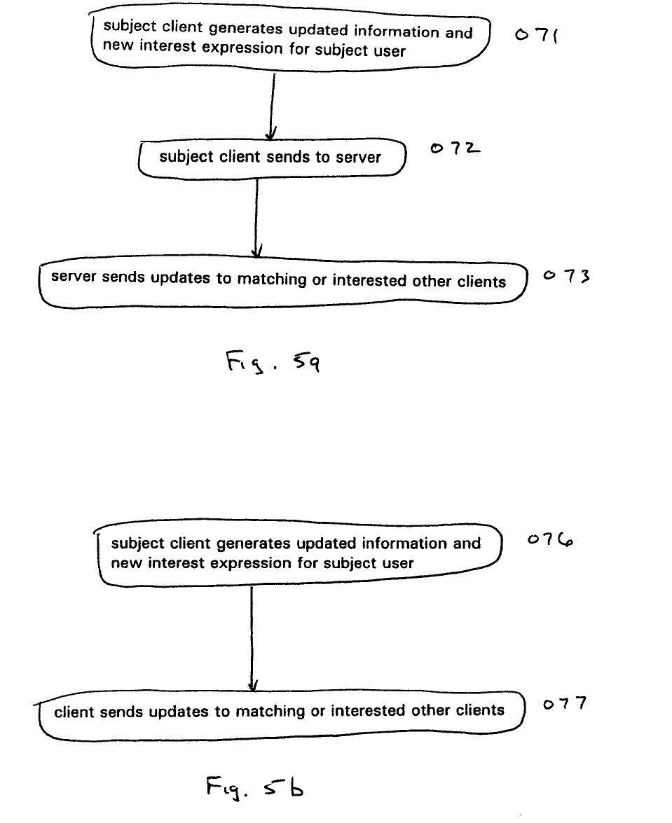

FIG. 5a illustrates in block form a first method for dynamically updating information of a subject client utilizing a server according to a preferred embodiment. Preferably, the operations of the method of FIG. 5a occur after operations that may be the same or similar to operations O1-O4 or O41-O44 of FIGS. 1 and 3, respectively. The method of FIG. 5a is preferably performed after an initial interest expression has been generated.

At operation O71, updated information and a new interest expression are generated for a subject user. The client associated with the subject user may perform this operation. The client may negotiate with a same or a different entity that the initial interest expression was negotiated with. For example, the initial interest expression may have been negotiated with an interactivity server, and the new interest expression may be negotiated with a local host other than the interactivity server, or two different other clients may perform negotiation with the subject client of the initial and new interest expressions. The updated may relate to updates in information relating to a zone or zones that the client is interested in, as well, or other information that may or may not affect any interest expressions of the client.

Once the new interest expression is generated, then the subject client sends the new interest expression to a server at operation O72. The same or a different server may have negotiated the initial or new interest expression with the subject client. The server that receives the updated information at operation O72, then sends updates to matching or interested clients at operation O73. Based on the information, one or more additional operations may be performed such as the changing from interesting to uninteresting, or vice-versa, of the subject client to the other clients, or vice-versa. Entities of interest or entities interested in me lists may be updated.

FIG. 5b illustrates in block form a second method for dynamically updating information of a subject client relating to a peer-to-peer, nodal or hybrid network software program according to a preferred embodiment. Operation O76 of the method of FIG. 5b is preferably the same or similar to operation O71 of the method of FIG. 5a. At operation O77, the subject client sends updates to matching or interested other clients. In this second method, then, there is no intermediate operation involving a server.

A server may have been used to connect and negotiate the initial interest expression, whereas exchange of updates occur between clients or in a peer-to-peer format. This represents a preferred hybrid network architecture. The connection, communication of context and negotiation of the initial interest expression of the subject client may have been performed with another client, such as may be a node of a nodal architecture. Alternatively, the entire network may be peer-to-peer, wherein an interactivity server is not used even at the initial connection of the subject user. Some alternative network configurations are set forth at FIGS. 8a-8d.

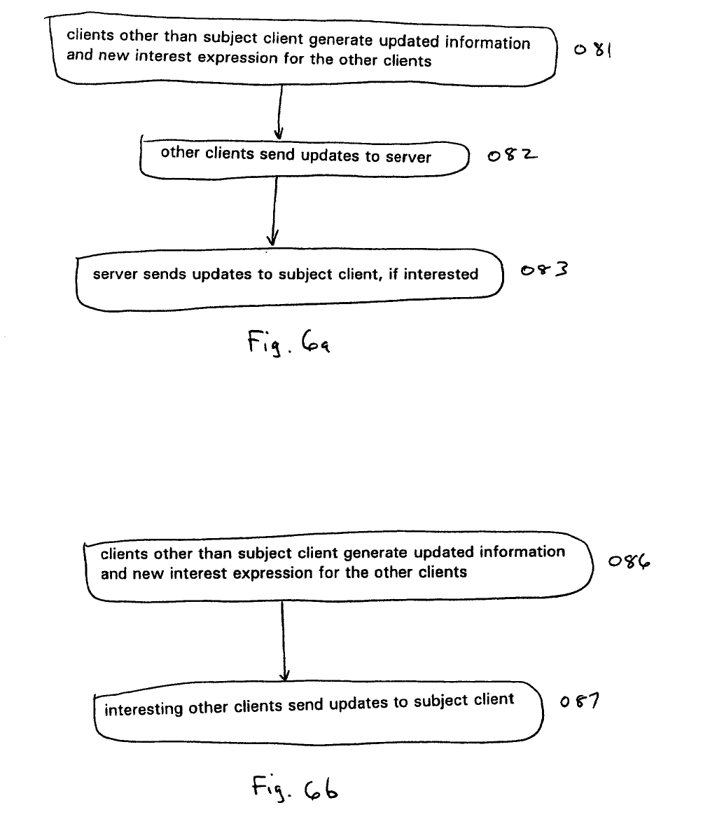

FIG. 6a illustrates in block form a first method for dynamically updating information of clients other than a subject client utilizing a server according to a preferred embodiment. The method of FIG. 6a represents the reverse of communicating updates relating to the subject client to other clients, such as is set forth at FIG. 5a. At operation O81, a client other than the subject client generates updated information, or information relating to the other client is generated other than at the subject client, and a new interest expression may be generated for that other client. A server receives the updates of the other clients as operation O82. The server then sends the updated information to the subject user, if the subject user is interested. A determination may be made as to whether the subject user would be interested in any of these other clients after revising the subject user's entities of interest list based at least in part on the updated information of the other users.

FIG. 6b illustrates in block form a second method for dynamically updating information of clients other than a subject client relating to a peer-topeer, nodal or hybrid network software program according to a preferred embodiment. The method represents the reverse of communicating updates relating to the subject client to other clients, as set forth at FIG. 6b. At operation O86, a client other than the subject client generates updated information, or information relating to the other client is generated other than at the subject client, and a new interest expression may be generated for that other client. At operation O87, interesting other clients send updates to the subject client. The other clients may become uninteresting or may become interesting based on the update, e.g., such that the subject client may receive information about this other client for the first time or such that information from a previously interesting other client is now filtered from being transmitted to the subject client.

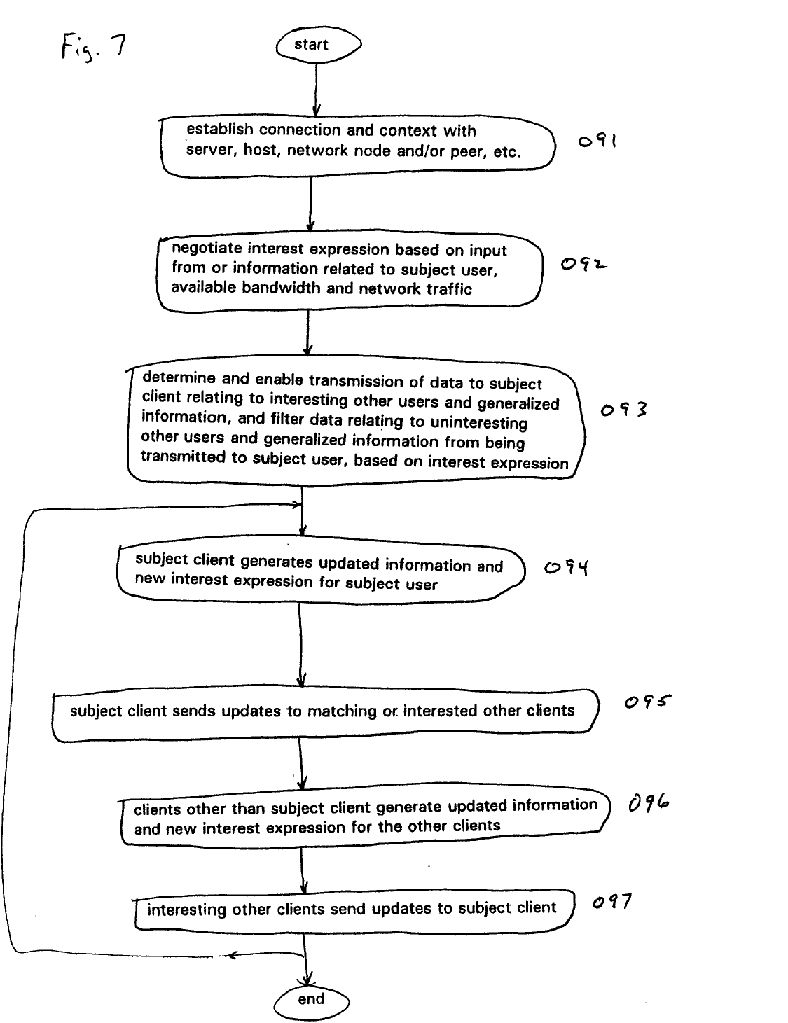

FIG. 7 illustrates in block form a method relating to a hybrid, peer-to-peer, nodal or alternate host network software program according to a preferred embodiment. At operation O91, a connection and context are established with the server, host, network node, peer, etc. by the subject client, the same as or similar to operations O1 and O41 of FIGS. 1 and 3, above. An interest expression is negotiated at operation O92, preferably between the subject client and the interactivity server, e.g., for a hybrid architecture.

At operation O93, it is determined which other users and/or generalized information is interesting to the subject user, whereby transmission is enabled of that information to the client associated with the subject user. Those other users and/or generalized information that are uninteresting to the subject user are filtered from being transmitted to the subject user, also at operation O93.

At operation O94, the subject client generates updated information for or relating to the subject user, such as may be input by the subject user, relates to activities of the subject user, depends on a location in the simulation that the subject user is in, etc. Preferably, a new interest expression is negotiated based at least in part on the updated information, and alternatively, the renegotiation of the interest expression is not performed at this time or in association with this operation.

At operation O95, the subject client send updates to matching or interested other clients relating to the updated information generated at operation O94. In the hybrid communications method, wherein the server is initially used for establishing context and negotiating an initial interest expression, the server is not used in this updating operation. The information may channel through a node client of a nodal architecture, and alternate host or a nearest or selected peer if a peer-to-peer architecture is used.

At operation O96, clients other than the subject client generate updated information. Preferably, but not necessarily, new interest expressions are negotiated at this point for these other clients. The subject client is sent an update for each matching or interesting other client at operation O97. Another client may become interesting based on the updated information, wherein that client was previously uninteresting. Updates may be continuously generated and sent according to operations O94-O97 of FIG. 7.

FIGS. 8a-8e schematically illustrate alternative network architectures that may be used in practicing the invention. As indicated throughout the description of the preferred embodiment, the invention is not limited to a particular network architecture and may be practiced with several architectures such as those shown at FIGS. 8a-8e and others known to those skilled in the art or that may become useful in the future.

FIG. 8a illustrates a server centered network architecture according to a preferred embodiment. An interactivity server is shown connected to each of client 1-client 4 in FIG. 8a. Information received by each of the clients 1-4 is typically sent from the server to the clients 1-4. Information, e.g., sent from client 1 to client 2 would be initially sent by client 1 to the server, and then would be sent from the server to client 2. There may be intermediate servers, clients, routers, etc. involved in the communication from client 1 to client 2. In addition, communications to other clients, i.e., other than clients 1-4 by one of clients 1-4 will also go out through the server, and communications received by any of clients 1-4 are received first by the server and then sent to the clients 1-4 by the server.

FIG. 8b illustrates a peer-to-peer network architecture according to a preferred embodiment. Each client is connected to each other client. There may be, especially for other very than small networks, other routers and servers in between. However, there is no particularly server that is used to send and receive all communications from any client. Preferably, a client can receive a communication from another client via one or more routers and perhaps one or more clients without going through a server.

FIG. 8c illustrates a hybrid network architecture according to a preferred embodiment. In the hybrid network of FIG. 8c, communications take place between each of clients 1-3 and the server, and between the clients themselves. An example of how this hybrid communication may be structured in at FIG. 7, and has been otherwise discussed with respect to some of FIGS. 1-6b. Thus, the interactivity server may be used to establish an initial connection and context with each client, and preferably also to negotiate an initial interest expression or set of initial interest expressions and/or to carve out zones of interest for the client. Perhaps, an initial set of interested other users and/or generalized information may be generated with help from the server, and other clients may be made initially aware of their interest or lack or interest in the subject user with help from the server.

At some point after these initial operations are performed which involve the server, the client begins to communicate and interact without the server being involved. That is, client 1 can communicate with client 2 update information, which may be an email or other input from the user of client 1, or an activity update sent directly by client 1, or an available bnadwidth or traffic update, etc., without the server being involved. Again, other servers or routers or clients may be used, but the initial interactivity server described above is not.

FIG. 8d illustrates a nodal architecture according to a preferred embodiment. In this architecture, clients are connected through each other in a web. Client 7 is thus connected to the network, e.g., at client 6, and may communicate with client 3 through client 6 and client 5, or through client 6 and client 4, depending on traffic and bandwidth. There may be many ways to traverse the web of nodal clients, some of which may go through a server or servers. In this architecture, the client may initially connect and establish context with another client, rather than an interactivity server. Communications of updates later may or may not involve an interactivity server. Information may be spread from client to client along the nodal architecture, wherein the information may be maintained due to multiple clients being logged in at any particular time.

FIG. 8e shows an illustration 350 of members grouped as one or more multicast groups 352a-352n. Each of the members of a group (e.g. 354a-354n in group 352a) is connected to a network such as the Internet. Individual members are free to join or leave a multicast group at any time. There are no restrictions on the physical location or the number of members in a multicast group. A member may be a member of more than one multicast group at any given time and does not have to belong to a group to send/receive messages to members of the group. According to one embodiment, a group membership protocol is employed by routers to learn about the presence of group members on their directly attached to a network. When a member joins a multicast group, it transmits a group membership protocol message for the group(s) that it wishes to communicate with, and sets its IP process and network interface card to receive frames addressed to the multicast group. In operation, one request member desires responses to its query from a particular multicast group (e.g. group 352a), the query is then multicast to the group. If any member in the group has information pertaining to the query, a response may be forwarded back to the request member. This receiver-initiated join process has excellent scaling properties since, as the multicast group increases in size, it becomes ever more likely that responses to a query will be received.

In the multicast architecture of FIG. 8e, many clients are connected to a single client or any client or some clients or each client. A client may be a member of any number of groups. The software ensures that a client is connected and may communicate with each of the clients in a particular group over the network, such that messages from the client and directed to the group will be routed to each of the clients in the group. Thus, a client, e.g., client 1, may message all of the clients in a particular group either simultaneously or independently. Each of the clients in the group may also choose whether to receive communications from client 1, or may choose whether a specific message, e.g., sent to a specific channel or group, from client 1 will be received. Thus, client 1 may send a message to a specified group that may be subscribed to by many other clients, and that may be unsubscribed by thiose clients at any time. Client 1 may create its own channel dedicated to messages to be sent to clients 2-6, e.g., and may add or subtract clients from the channel as desired. Preferably a network is provided that permits all clients to have this multicast capability.

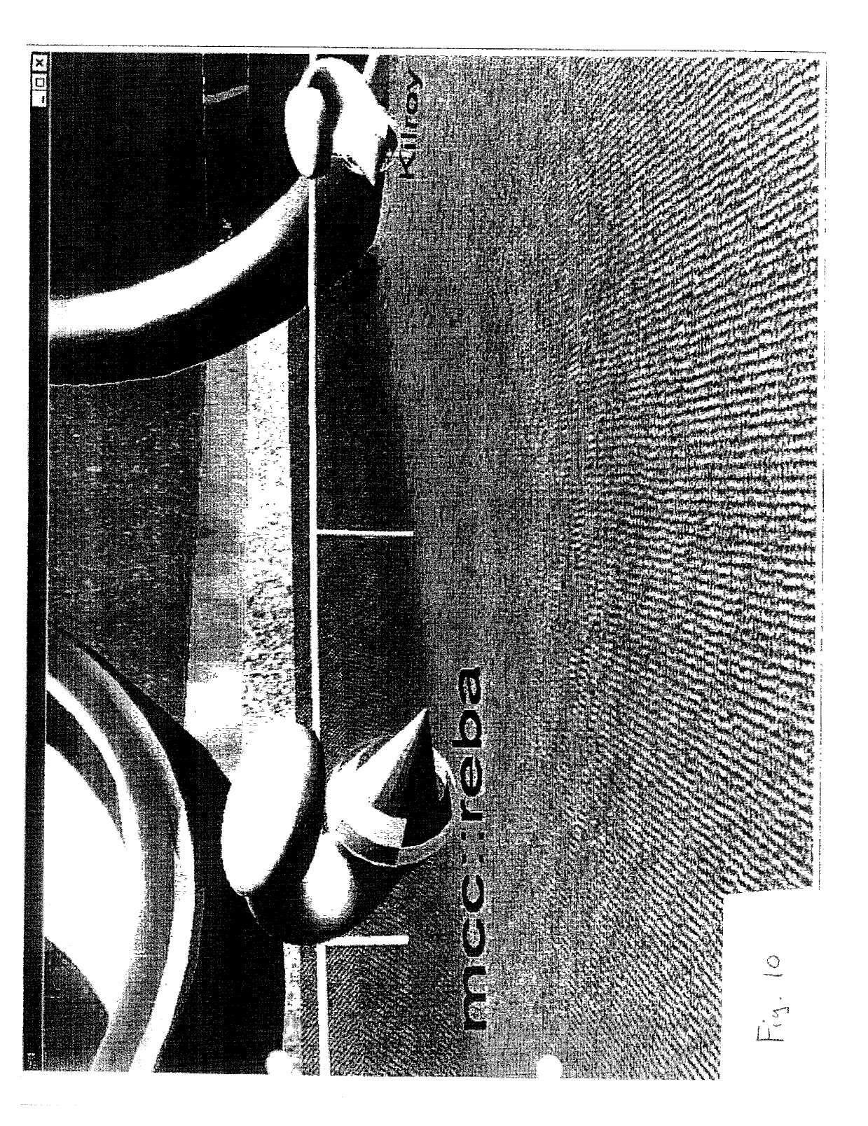

FIG. 9 is a first illustration of a shared 3D virtual environment including representative user objects according to a preferred embodiment. FIG. 9 shows a three-dimensional multiple user shared virtual environment or network space. Three user objects are visible in FIG. 9. The space itself may be perceived by others or advertised as being relevant to users interested in a particular activity, item or product. For example, people may go into this room who are interested in discussing, purchasing, selling, doing, watching, etc. this particular activity, item or product. The activity associated with the space may be very narrow or very broad as to how it is perceived. Thus, there may be some bias toward those other users in the space being interesting to a subject user, and vice-versa. In addition, the virtual proximity of user objects in a same space, such as the three user objects in the space shown at FIG. 9, makes it convenient for those users to at least check out whether they are interested in each other or not with some priority over users whose user objects are located in another space and not visible in the simulation.

The user object associated with a user may be indicative of interests of a user. For example, shape or colors of the user object may indicate something that is apparent to another user. In addition, the manner in which the user object is manipulated in the simulation may interest or disinterest other users. Features of a subject user hidden from view, but accessible to other users, may also interest or disinterest another user.

FIG. 10 is a second illustration of a shared 3D virtual environment including representative user objects according to a preferred embodiment. In FIG. 10, two user objects are shown very close together in the simulated three-dimensional environment. It may be that the users represented by user objects Kilroy and Reba, and interested in each other or are checking each other out. It may be that Kilroy is interested in Reba, but that Reba is not certain of her interest yet in Kilroy, among other possibilities.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow, and equivalents thereof.

In addition, in the method claims that follow, the operations have been ordered in selected typographical sequences. However, the sequences have been selected and so ordered for typographical convenience and are not intended to imply any particular order for performing the operations, except for those claims wherein a particular ordering of steps is expressly set forth or understood by one of ordinary skill in the art as being necessary.

What is claimed is:

1. A method for managing interests and/or communications of a client associated with a subject user among multiple users in a shared network environment for efficiently using available data transmission capabilities and/or providing to a user associated with the client efficient communications access to interesting other users and information, the method comprising operations of:
establishing a connection and a context with an interactivity server over a computer network;
negotiating an interest expression with the interactivity server based on information relating to the subject user and based on available bandwidth and network traffic; and
enabling, based on said interest expression, transmission to the client of interesting entities, and filtering of uninteresting entities.

2. The method of claim 1, the method comprising a further operation of enabling transmission to other users having an interest in the subject user information relating to the subject user, and filtering transmission to other users not having an interest in the subject user said information relating to the subject user.

3. The method of any of claims 1 or 2, the method comprising further operations of:
sending dynamic interest update information to the server; and
negotiating an updated interest expression based at least in part on said dynamic interest update information, and on available bandwidth and network traffic.

4. The method of claim 3, the method comprising a further operation of enabling, based on said updated interest expression, transmission to the client of additional interesting entities, and filtering of now uninteresting entities of said previously interesting entities based on said previous interest expression.

5. The method of claim 4, the method comprising a further operation of enabling, based on said updated interest expression, transmission to additional other users now having an interest in the subject user information relating to the subject user, and filtering transmission to other users previously having an interest in the subject user based on said previous interest expression said information relating to the subject user.

6. The method of any of claims 1 or 2, the method comprising a further operation of receiving dynamic updates from or relating to said interesting entities.

7. The method of any of claims 1 or 2, the method comprising a further operation of receiving interesting generalized information from said uninteresting entities.

8. The method of any of claims 1 or 2, the method comprising a further operation of enabling, based on said interest expression, transmission to the client of now interesting entities, who were previously uninteresting, based on updated information relating to said previously uninteresting entities.

9. The method of any of claims 1 or 2, the method comprising a further operation of enabling, based on said interest expression, filtering of now uninteresting entities, who were previously interesting, based on updated information relating to said previously interesting entities.

10. The method of any of claims 1 or 2, the method comprising a further operation of generating a three-dimensional viewing environment to facilitate user interfacing with said multi-user shared virtual environment.

11. The method of claim 10, the method comprising a further operation of incorporating a mark-up language object within said three-dimensional viewing environment.

12. The method of any of claims 1 or 2, wherein said information relating to said subject user includes a boolean expression input by said subject user.

13. The method of any of claims 1 or 2, wherein said information relating to said subject user includes interactions of the subject user with other users.

14. The method of any of claims 1 or 2, wherein said information relating to said subject user includes preferences of said subject user.

15. The method of any of claims 1 or 2, wherein said information relating to said subject user includes past activities of said subject user.

16. A method for managing interests and/or communications of a client associated with a subject user among multiple users in a shared network environment for efficiently using available data transmission capabilities and/or providing to a user associated with the client efficient communications access to interesting other users and information, the method comprising operations of:
establishing a connection and a context with a host over a computer network;
negotiating an interest expression with the host based on information relating to the subject user and based on available bandwidth and network traffic; and
enabling, based on said interest expression, transmission to the client of interesting entities, and filtering of uninteresting entities.

17. The method of claim 16, the method comprising a further operation of enabling transmission to other users having an interest in the subject user information relating to the subject user, and filtering transmission to other users not having an interest in the subject user said information relating to the subject user.

18. The method of claim 16, the method comprising a further operation of selecting another client as said host.

19. The method of claim 17, the method comprising a further operation of selecting another client as said host.

20. The method of any of claims 1-2 or 16-17 or 19, the method comprising further operations of:
generating dynamic interest update information; and
sending said dynamic interest update information to interested other users.

21. The method of any of claims 1-2 or 16-18, the method comprising a further operation of receiving dynamic interest update information from interesting other entities.

22. A method for managing communications among multiple clients in a shared network environment using an interactivity server for efficiently using available data transmission capabilities for providing to users within said environment connected to the interactivity server efficient communications access to interesting other users and information, the method comprising operations of:
establishing a connection and a context with a client over a computer network;
negotiating an interest expression with said client based on information relating to a subject user associated with said client, and based on available bandwidth and network traffic; and
permitting, based on said interest expression, transmission to the client of entities, while filtering uninteresting entities.

23. The method of claim 22, the method comprising a further operation of permitting transmission to other users having an interest in the subject user information relating to the subject user, while filtering said information relating to the subject user from being transmitted to other users not having an interest in the subject user.

24. The method of any of claims 22 or 23, the method comprising further operations of:
receiving dynamic interest update information from the client; and
negotiating an updated interest expression based at least in part on said dynamic interest update information, and on available bandwidth and network traffic.

25. The method of claim 24, the method comprising a further operation of permitting, based on said updated interest expression, transmission to the client of additional interesting entities, and filtering of now uninteresting entities of said previously interesting entities based on said previous interest expression.

26. The method of claim 25, the method comprising a further operation of permitting, based on said updated interest expression, transmission to additional other users now having an interest in the subject user information relating to the subject user, and filtering transmission to other users previously having an interest in the subject user based on said previous interest expression said information relating to the subject user.

27. The method of any of claims 22 or 23, the method comprising a further operation of permitting transmission of dynamic updates to said client from or relating to said interesting other entities.

28. The method of any of claims 22 or 23, the method comprising a further operation of permitting transmission of interesting generalized information to said client from said uninteresting other entities.

29. The method of any of claims 22 or 23, the method comprising a further operation of permitting, based on said interest expression, transmission to the client of now interesting entities, who were previously uninteresting, based on updated information relating to said previously uninteresting other entities.

30. The method of any of claims 22 or 23, the method comprising a further operation of permitting, based on said interest expression, filtering of now uninteresting entities, who were previously interesting, based on updated information relating to said previously interesting other entities.

31. The method of any of claims 22 or 23, the method comprising a further operation of generating a three-dimensional viewing environment to facilitate user interfacing with said multi-user shared virtual environment.

32. The method of claim 31, the method comprising a further operation of incorporating a mark-up language object within said three-dimensional viewing environment.

33. The method of any of claims 22 or 23, wherein said information relating to said subject user includes a boolean expression input by said subject user.

34. The method of any of claims 22 or 23, wherein said information relating to said subject user includes interactions of said subject user with other users.

35. The method of any of claims 22 or 23, wherein said information relating to said subject user includes preferences of said subject user.

36. The method of any of claims 22 or 23, wherein said information relating to said subject user includes past activities of said subject user.

37. A client software program running on a computer associated with a subject user connected to a network including other computers associated with multiple other users of a shared virtual environment for efficiently using available data transmission capabilities for providing to the subject user efficient communications access to interesting other entitites, the program providing instructions to one or more processors of the client computer to perform operations of:
establishing a connection and a context with an interactivity server over a computer network;
negotiating an interest expression with the interactivity server based on information relating to the subject user, and based on available bandwidth and network traffic; and
enabling, based on said interest expression, transmission to the client of interesting entities, and filtering of uninteresting entities.

38. The software program of claim 37, further providing instructions to the one or more processors of the client computer to perform an operation of enabling transmission to other users having an interest in the subject user information relating to the subject user, and filtering transmission to other users not having an interest in the subject user said information relating to the subject user.

39. The software program of any of claims 37 or 38, further providing instructions to the one or more processors of the client computer to perform operations of:
sending dynamic interest update information to the server; and
negotiating an updated interest expression based at least in part on said dynamic interest update information, and on available bandwidth and network traffic.

40. The software program of claim 39, further providing instructions to the one or more processors of the client computer to perform an operation of enabling, based on said updated interest expression, transmission to the client of additional interesting entities, and filtering of now uninteresting entities of said previously interesting entities based on said previous interest expression.

41. The software program of claim 40, further providing instructions to the one or more processors of the client computer to perform an operation of enabling, based on said updated interest expression, transmission to additional other users now having an interest in the subject user information relating to the subject user, and filtering transmission to other users previously having an interest in the subject user based on said previous interest expression said information relating to the subject user.

42. The software program of any of claims 38 or 39, further providing instructions to the one or more processors of the client computer to perform an operation of receiving dynamic updates relating to said interesting other entities.

43. The software program of any of claims 38 or 39, further providing instructions to the one or more processors of the client computer to perform an operation of receiving interesting generalized information from said uninteresting other entities.

44. The software program of any of claims 38 or 39, further providing instructions to the one or more processors of the client computer to perform an operation of enabling, based on said interest expression, transmission to the client of now interesting entities, who were previously uninteresting, based on updated information relating to said previously uninteresting entities.

45. The software program of any of claims 38 or 39, further providing instructions to the one or more processors of the client computer to perform an operation of enabling, based on said interest expression, filtering of now uninteresting other entities, who were previously interesting, based on updated information relating to said previously interesting other entities.

46. The software program of any of claims 38 or 39, further providing instructions to the one or more processors of the client computer to perform an operation of generating a three-dimensional viewing environment to facilitate user interfacing with said multi-user shared virtual environment.

47. The software program of claim 46, further providing instructions to the one or more processors of the client computer to perform an operation of incorporating a mark-up language object within said three-dimensional viewing environment.

48. The software program of any of claims 38 or 39, wherein said information relating to said subject user includes a boolean expression input by said subject user.

49. The software program of any of claims 38 or 39, wherein said information relating to said subject user includes interactions of said subject user with other users.

50. The software program of any of claims 38 or 39, wherein said information relating to said subject user includes preferences of said subject user.

51. The software program of any of claims 38 or 39, wherein said information relating to said subject user includes past activities of said subject user.

52. A software program for managing interests and/or communications of a client associated with a subject user among multiple users in a shared network environment for efficiently using available data transmission capabilities and/or providing to a user associated with the client efficient communications access to interesting other users and information, the program providing instructions to one or more processors of the client computer to perform operations of:
establishing a connection and a context with a host over a computer network;
negotiating an interest expression with the host based on information relating to the subject user and based on available bandwidth and network traffic; and
enabling, based on said interest expression, transmission to the client of interesting entities, and filtering of uninteresting entities.

53. The software program of claim 52, further providing instructions to the one or more processors of the client computer to perform an operation of enabling transmission to other users having an interest in the subject user information relating to the subject user, and filtering transmission to other users not having an interest in the subject user said information relating to the subject user.

54. The software program of claim 52, further providing instructions to the one or more processors of the client computer to perform an operation of selecting another client as said host.

55. The software program of claim 53, further providing instructions to the one or more processors of the client computer to perform an operation of selecting another client as said host.

56. The software program of any of claims 38-39, 52-53 or 55, further providing instructions to the one or more processors of the client computer to perform operations of:
generating dynamic interest update information; and
sending said dynamic interest update information to interested other entities.

57. The software program of any of claims 38-39, or 52-54, further providing instructions to the one or more processors of the client computer to perform an operation of receiving dynamic interest update information from interesting other entities.

58. A server software program running on an interactivity server computer connected to a network including other computers associated with multiple users of a shared virtual environment for efficiently using available data transmission capabilities for providing to each user efficient communications access to interesting other entities, the program providing instructions to one or more processors of the server computer to perform operations of:
establishing a connection and a context with a client over a computer network;
negotiating an interest expression with said client based on information relating to a subject user associated with said client, and based on available bandwidth and network traffic; and
permitting, based on said interest expression, transmission to the client of interesting entities, while filtering uninteresting entities.

59. The software program of claim 58, further providing instructions to the one or more processors of the server computer to perform an operation of permitting transmission to other users having an interest in the subject user information relating to the subject user, while filtering said information relating to the subject user from being transmitted to other users not having an interest in the subject user.

60. The software program of any of claims 58 or 59, further providing instructions to the one or more processors of the server computer to perform operations of:
receiving dynamic interest update information from the client; and
negotiating an updated interest expression based at least in part on said dynamic interest update information, and on available bandwidth and network traffic.

61. The software program of claim 60, further providing instructions to the one or more processors of the server computer to perform an operation of permitting, based on said updated interest expression, transmission to the client of additional interesting entities, and filtering of now uninteresting entities of said previously interesting entities based on said previous interest expression.

62. The software program of claim 61, further providing instructions to the one or more processors of the server computer to perform an operation of permitting, based on said updated interest expression, transmission to additional other users now having an interest in the subject user information relating to the subject user, and filtering transmission to other users previously having an interest in the subject user based on said previous interest expression said information relating to the subject user.

63. The software program of any of claims 58 or 59, further providing instructions to the one or more processors of the server computer to perform an operation of permitting transmission of dynamic updates to said client relating to said interesting other entities.

64. The software program of any of claims 58 or 59, further providing instructions to the one or more processors of the server computer to perform an operation of permitting transmission of interesting generalized information to said client from said uninteresting other entities.

65. The software program of any of claims 58 or 59, further providing instructions to the one or more processors of the server computer to perform an operation of permitting, based on said interest expression, transmission to the client of now interesting entities, who were previously uninteresting, based on updated information relating to said previously uninteresting other entities.

66. The software program of any of claims 58 or 59, further providing instructions to the one or more processors of the server computer to perform an operation of permitting, based on said interest expression, filtering of now uninteresting entities, who were previously interesting, based on updated information relating to said previously interesting other entities.

67. The software program of any of claims 58 or 59, further providing instructions to the one or more processors of the server computer to perform an operation of generating a three-dimensional viewing environment to facilitate user interfacing with said multi-user shared virtual environment.

68. The software program of claim 67, further providing instructions to the one or more processors of the server computer to perform an operation of incorporating a mark-up language object within said three-dimensional viewing environment.

69. The software program of any of claims 58 or 59, wherein said information relating to said subject user includes a boolean expression input by said subject user.

70. The software program of any of claims 58 or 59, wherein said information relating to said subject user includes interactions by said subject user with other users.

71. The software program of any of claims 58 or 59, wherein said information relating to said subject user includes preferences of said subject user.

72. The method of any of claims 58 or 59, wherein said information relating to said subject user includes past activities of said subject user.

73. A computer network running software for allowing multiple users to communicate in a shared virtual environment while efficiently using available data transmission capabilities for providing to each user efficient communications access to interesting other entities, comprising:
an interactivity server; and
a plurality of client computers each connected to each other and said interactivity server, wherein said software provides instructions for processors of said interactivity server and each client computer to perform operations of:
establishing a connection and a context between said server and said each client computer;
negotiating an interest expression of said each client based on information relating to a subject user associated with said each client, and based on available bandwidth and network traffic;
permitting transmission to said each client of interesting entities, while filtering uninteresting entities.

74. The computer network of claim 73, said software further providing instructions to the one or more processors to perform an operation of permitting transmission to other users having an interest in the subject user information relating to the subject user, while filtering said information relating to the subject user from being transmitted to other users not having an interest in the subject user.

75. The computer network of any of claims 73 or 74, said software further providing instructions to the one or more processors to perform operations of:
permitting transmission of dynamic interest update information from the client; and
negotiating an updated interest expression based at least in part on said dynamic interest update information, and on available bandwidth and network traffic.

76. The computer network of claim 75, said software further providing instructions to the one or more processors to perform an operation of permitting, based on said updated interest expression, transmission to the client of additional interesting entities, and filtering of now uninteresting entities of said previously interesting entities based on said previous interest expression.

77. The computer network of claim 76, said software further providing instructions to the one or more processors to perform an operation of permitting, based on said updated interest expression, transmission to additional other users now having an interest in the subject user information relating to the subject user, and filtering transmission to other users previously having an interest in the subject user based on said previous interest expression said information relating to the subject user.

78. The computer network of any of claims 73 or 74, said software further providing instructions to the one or more processors to perform an operation of permitting transmission of dynamic updates to said client relating to said interesting other entities.

79. The computer network of any of claims 73 or 74, said software further providing instructions to the one or more processors to perform an operation of permitting transmission of interesting generalized information to said client from said uninteresting other entities.

80. The computer network of any of claims 73 or 74, said software further providing instructions to the one or more processors to perform an operation of permitting, based on said interest expression, transmission to the client of now interesting entities, who were previously uninteresting, based on updated information relating to said previously uninteresting other entities.

81. The computer network of any of claims 73 or 74, said software further providing instructions to the one or more processors to perform an operation of permitting, based on said interest expression, filtering of now uninteresting other entities, who were previously interesting, based on updated information relating to said previously interesting other entities.

82. The computer network of any of claims 73 or 74, said software further providing instructions to the one or more processors to perform an operation of generating a three-dimensional viewing environment to facilitate user interfacing with said multi-user shared virtual environment.

83. The computer network of claim 82, said software further providing instructions to the one or more processors to perform an operation of incorporating a mark-up language object within said three-dimensional viewing environment.

84. The computer network of any of claims 73 or 74, wherein said information relating to said subject user includes a boolean expression input by said subject user.

85. The computer network of any of claims 73 or 74, wherein said information relating to said subject user includes interactions by said subject user with other users.

86. The computer network of any of claims 73 or 74, wherein said information relating to said subject user includes preferences of said subject user.

87. The computer network of any of claims 73 or 74, wherein said information relating to said subject user includes past activities of said subject user.

88. A computer network running software for allowing multiple users to communicate in a shared virtual environment while efficiently using available data transmission capabilities for providing to each user efficient communications access to interesting other entities, comprising:
a plurality of client computers each connected within the network, wherein said software provides instructions for at least one processor of each client computer to perform operations of:
establishing a connection and a context between a host and said each client computer;
negotiating an interest expression of said each client based on information relating to a subject user associated with said each client, and based on available bandwidth and network traffic;
enabling transmission to said each client of interesting entities, while filtering uninteresting entities.

89. The computer network of claim 88, said software further providing instructions to the at least one processor to perform an operation of enabling transmission to other users having an interest in the subject user information relating to the subject user, while filtering said information relating to the subject user from being transmitted to other users not having an interest in the subject user.

90. The computer network of any of claims 88 or 89, said software further providing instructions to the one or more processors to perform operations of:
enabling transmission of dynamic interest update information from the client; and
negotiating an updated interest expression based at least in part on said dynamic interest update information, and on available bandwidth and network traffic.

91. The computer network of claim 90, said software further providing instructions to the at least one processor to perform an operation of enabling, based on said updated interest expression, transmission to the client of additional interesting entities, and filtering of now uninteresting entities of said previously interesting entities based on said previous interest expression.

92. The computer network of claim 91, said software further providing instructions to the at least one processor to perform an operation of enabling, based on said updated interest expression, transmission to additional other users now having an interest in the subject user information relating to the subject user, and filtering transmission to other users previously having an interest in the subject user based on said previous interest expression said information relating to the subject user.

93. The computer network of any of claims 88 or 89, said software further providing instructions to the one or more processors to perform an operation of enabling transmission of dynamic updates to said client relating to said interesting other entities.

94. The computer network of any of claims 88 or 89, said software further providing instructions to the at least one processor to perform an operation of enabling transmission of interesting generalized information to said client from said uninteresting other entities.

95. The computer network of any of claims 88 or 89, said software further providing instructions to the at least one processor to perform an operation of enabling, based on said interest expression, transmission to the client of now interesting entities, who were previously uninteresting, based on updated information relating to said previously uninteresting other entities.

96. The computer network of any of claims 88 or 89, said software further providing instructions to at least one processor to perform an operation of enabling, based on said interest expression, filtering of now uninteresting entities, who were previously interesting, based on updated information relating to said previously interesting other entities.

97. The computer network of any of claims 88 or 89, said software further providing instructions to the one or more processors to perform an operation of generating a three-dimensional viewing environment to facilitate user interfacing with said multi-user shared virtual environment.

98. The computer network of claim 97, said software further providing instructions to the one or more processors to perform an operation of incorporating a mark-up language object within said three-dimensional viewing environment.

99. The computer network of any of claims 88 or 89, wherein said information relating to said subject user includes a boolean expression input by said subject user.

100. The computer network of any of claims 88 or 89, wherein said information relating to said subject user includes interactions of said subject user with other users.

101. The computer network of any of claims 88 or 89, wherein said information relating to said subject user includes preferences of said subject user.

102. The computer network of any of claims 88 or 89, wherein said information relating to said subject user includes past activities of said subject user.

103. The computer network of any of claims 88 or 89, wherein said host is another client computer.
